(19) United States
(12) Patent Application Publication
(10) Pub. No.: US 2003/0038435 A1
(43) Pub. Date: Feb. 27, 2003

(54) Low profile snow sled with rear rudder

(76) Inventor: Andrew F. Fireman, North Bethesda, MD (US)

Correspondence Address: Steven N. Fox, Esq., P.O. Box 251, Canton, MA, 02021, US

(21) Appl. No.: 09/935,049

(22) Filed: Aug. 22, 2001

(51) Int. Cl. B62M 29/00; B62M 27/00

(52) U.S. Cl. 280/21.1

(57) ABSTRACT

The present invention is a sled for use by a person on snow. The sled comprises a low profile body member comprising an upper portion and a bottom portion adapted slide upon the snow. The upper portion comprises a front portion and a rear portion. The rear portion comprises a seat portion adapted for seating by the person. The sled further comprises a low profile rudder member moveably engaged with the rear portion. The low profile rudder member has a handle portion and a snow engagement portion adapted to be in contact with the snow. In operation, the person may grip and move the handle portion thereby causing movement of the snow engagement portion.

### FIELD OF THE INVENTION

The present invention relates to snow sleds used for recreational. More specifically, the present invention relates to snow sleds that can be steered by a person.

### BACKGROUND OF THE INVENTION

A wide variety of snow sleds have been designed that allow a person to steer the sled as it slides down a hill of snow. Such designs have focused on a steering mechanism located at the front of the sled. Such snow sleds have several drawbacks, including that of requiring the person to lie flat on their stomach which may cause injury or be uncomfortable for some people.

### SUMMARY OF THE INVENTION

The present invention is a snow sled designed so that a person may sit upright while steering the snow sled. The snow sled comprises a low profile body member comprising an upper portion and a bottom portion adapted slide upon the snow. The upper portion comprises a front portion and a rear portion. The rear portion comprises a seat portion adapted for seating by the person. The snow sled further comprises a low profile rudder member moveably engaged with the rear portion. The low profile rudder member has a handle portion and a snow engagement portion adapted to be in contact with the snow. In operation, the person may grip and move the handle portion thereby causing movement of the snow engagement portion.

### BRIEF DESCRIPTION OF THE DRAWINGS

The following detailed description of the invention will be more fully understood with reference to the accompanying drawings in which:

FIG. 1 is a top plan view of a snow sled of the present invention;

FIG. 2 is cross sectional view taken along line 2-2 of FIG. 1; and

FIG. 3 is a bottom plan view of the snow sled.

### DETAILED DESCRIPTION OF THE INVENTION

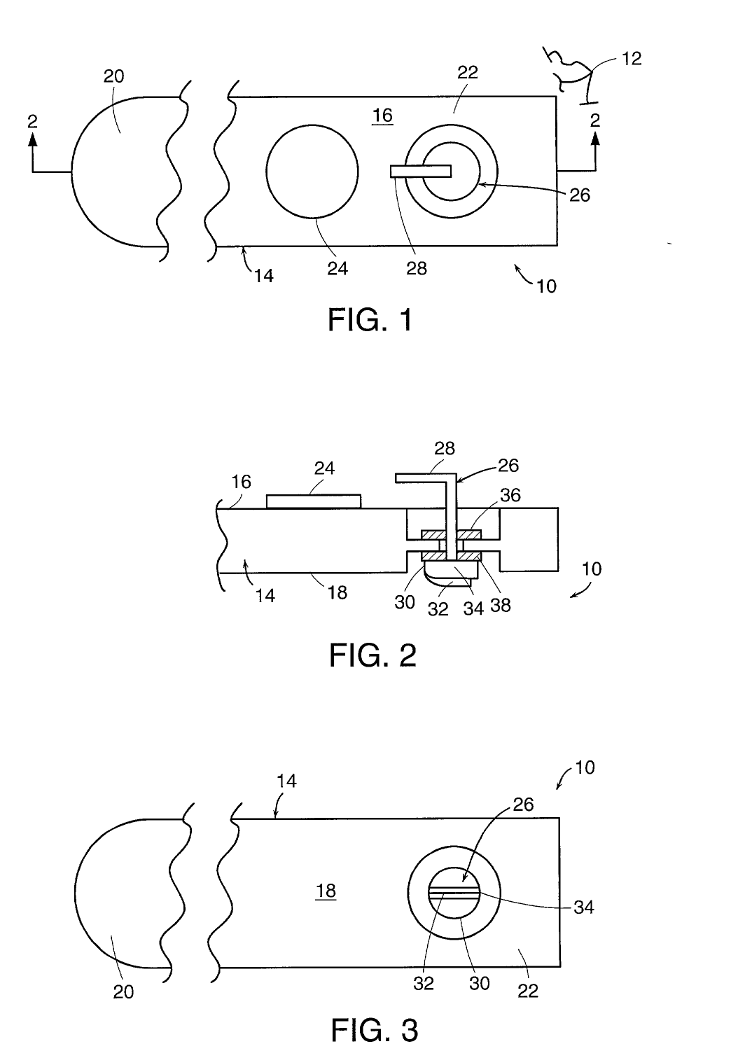

Referring to FIGS. 1-2, where a first embodiment of the snow sled 10 is shown on a snow surface 12. The sled 10 generally comprises a low profile body member 14 having an upper portion 16 and a bottom portion 18 adapted slide upon the snow 12. The upper portion 16 comprises a front portion 20 and a rear portion 22. The rear portion 22 comprises a seat portion 24 adapted for seating by a person. The snow sled 10 further comprises a low profile rudder member 26 moveably engaged with the rear portion 22. The low profile rudder member 26 has a handle portion 28 and a snow engagement portion 34 adapted to be in contact with the snow. The snow engagement portion 34 comprises a curved front portion 30 and a central blade portion 32. The low profile rudder 26 may be engaged within the rear portion 22 of the body member 14 by use of retention rings or members 36 and 38. The overall height of the body member 14 is less than eighteen (18) inches. The body member 14 and the rudder member 26 may be made from a plastic material and formed using injection and/or blow molding processes. In operation, the person may grip and move the handle portion 28 thereby causing movement of the snow engagement portion 30 and steering of the snow sled 10. The foregoing description is intended primarily for purposes of illustration. This invention may be embodied in other forms or carried out in other ways without departing from the spirit or scope of the invention.

What is claimed is:

1. A sled for use by a person on snow, the sled comprises a low profile body member comprising an upper portion and a bottom portion adapted slide upon the snow, said upper portion comprising a front portion and a rear portion, said rear portion comprising a seat portion adapted for seating by the person; and a low profile rudder member moveably engaged with said rear portion, said low profile rudder member having a handle portion and a snow engagement portion adapted to be in contact with the snow, whereby the person may grip and move said handle portion thereby causing movement of said snow engagement portion.

2. The sled of claim 1, wherein said first rudder member is rotatably mounted to said rear portion.

3. The sled of claim 2, wherein said first rudder member is positioned rearward of said seat portion.

4. The sled of claim 3, wherein said handle portion is disposed slightly above said upper portion.
